(19) United States
(12) Patent Application Publication
(10) Pub. No.: US 2007/0032995 A1
(43) Pub. Date: Feb. 8, 2007

(54) Method and system for real time graphical visualization of reservoir simulation data

(76) Inventor: Mark Chih-Hung Chien, Danville, CA (US)

Correspondence Address: Mark C. H. Chien, 125 Gerbera Street, Danville, CA, 94506, US

(21) Appl. No.: 11/196,834

(22) Filed: Aug. 4, 2005

(51) Int. Cl. G06G 7/48

(52) U.S. Cl. 703/10

(57) ABSTRACT

A method for real time graphical visualizing of reservoir simulation data is disclosed. The method comprises the following exemplary steps. First, a TCP/IP network layer is added to the reservoir simulator. The network layer has a listening port that is actively listening to the messages from graphical visualization tools once the simulation is started. Second, a TCP/IP network layer is added to the graphical visualization tool. The network layer is a vehicle for transmitting information to and from a reservoir simulator. Once started, the graphical visualization tool will make a network connection to the reservoir simulator via the listening port of the simulator. Subsequently, the graphical visualization tool makes request to the reservoir simulator for reservoir simulation information for the purpose of display. The reservoir simulator will send reservoir simulation information as requested. The graphical visualization tool then displays this information in graphical form. Intermittently, the graphical visualization tool can send various requests to the simulator to alter the state of simulation such as pausing simulation or changing simulation input data.

### CROSS-REFERENCES TO RELATED APPLICATION(S)

The present application claims the benefit of priority under 35 U.S.C. § 119 from U.S. Provisional Patent Application Ser. No. [to be assigned], entitled “METHOD AND SYSTEM FOR REAL TIME GRAPHICAL VISUALIZATION OF RESERVOIR SIMULATION DATA” filed on Aug. 1, 2005, the disclosure of which is hereby incorporated by reference in its entirety for all purposes.

### BACKGROUND OF THE INVENTION

The graphical visualization of simulation data of a reservoir simulator is a standard practice in the petroleum industry. Both the reservoir simulator and the graphical visualization tool exist in the form of computer software. The graphical visualization is generally performed before a reservoir simulation run or after a reservoir simulation run. The graphical visualization tool used before a reservoir simulation is known as part of functionality of a reservoir simulation preprocessor. They are used to display or edit simulation input files. The graphical visualization tool used after a reservoir simulation is known as part of functionality of a reservoir simulation postprocessor. They are used to display or edit simulation output files.

Current technology allows the graphical visualization prior or after a reservoir simulation run. Simulation results cannot be visualized while simulation is actively running. This causes inconvenience to reservoir simulation users and often delays the detection of a reservoir simulation problem. There is also no way of modifying input data via the graphical visualization tool until the simulation run is finished. Hence it would be desirable to provide a method and system which can display the graphical information in real time and which can modify simulation input data while the simulator is actively running.

### SUMMARY OF THE INVENTION

A method for real time graphical visualizing of reservoir simulation data is disclosed. According to an exemplary embodiment, the method comprises the following exemplary steps. First, a TCP/IP network layer is added to the reservoir simulator. The network layer has a listening port that is actively listening to the messages from graphical visualization tools once the simulation is started. Second, a TCP/IP network layer is added to the graphical visualization tool. The network layer is a vehicle for transmitting information to and from a reservoir simulator. Once started, the graphical visualization tool will make a network connection to the reservoir simulator via the listening port of the simulator. Subsequently, the graphical visualization tool makes request to the reservoir simulator for reservoir simulation information for the purpose of display. The reservoir simulator will send reservoir simulation information as requested. The graphical visualization tool then displays this information in graphical form. Intermittently, the graphical visualization tool can send various requests to the simulator to alter the state of simulation such as pausing simulation or changing simulation input data.

In an exemplary embodiment, the method as described above is implemented using computer software.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a flow diagram illustrating the operation of an exemplary method of the present invention.

### DETAILED DESCRIPTION OF THE INVENTION

The present invention in the form of one or more exemplary embodiments will now be described. According to an exemplary method of the present invention, the reservoir simulator and the graphical visualization tool are two independent, running processes communicating through network layers. Based on the disclosure provided herein, it will be appreciated by one of ordinary skill in the art that the two independent processes can be made to run in a single processor computer, a multiple processor computer, or computers across a computer network.

According to an exemplary method of the present invention, one graphical visualization tool is communicating to the reservoir simulator. Based on the disclosure provided herein, it will be appreciated by one of ordinary skill in the art that multiple graphical visualization tools can be made to communicate with one single reservoir simulator.

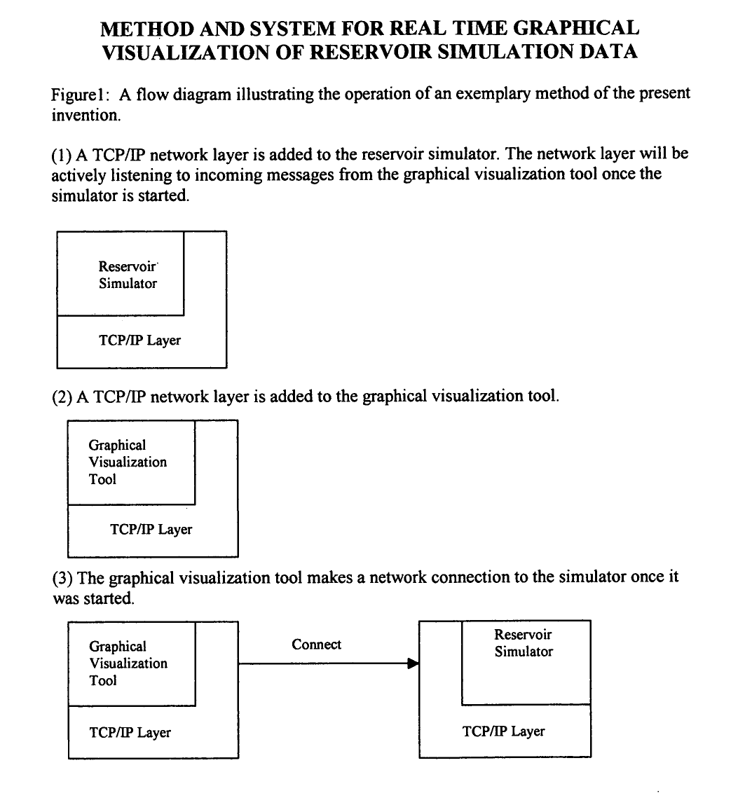

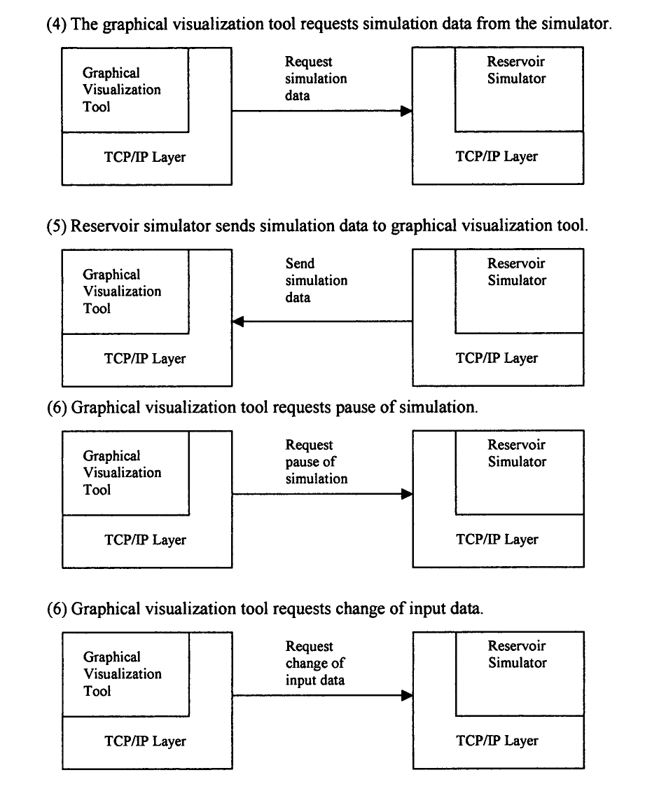

FIG. 1 is a flow diagram illustrating the exemplary operation of the real time graphical visualization. At Step 1, 2, and 3, a TCP/IP network layer was added to the reservoir simulator and the graphical visualization tool for the purpose of communicating reservoir information between the two computer software. Based on the disclosure provided herein, it will be appreciated by one of ordinary skill in the art that other type of network layers such as UDP can be added to the two software for communication purpose.

At Step 4, a request of reservoir simulation information is made from the graphical visualization tool to the reservoir simulator. At Step 5, the reservoir simulator sends the reservoir information to the graphical visualization tool for it to display. Based on the disclosure provided herein, it will be appreciated by one of ordinary skill in the art that many types of simulation information such as fluid property, rock property, porosity, permeability, pore volume, transmissibility, pressure, saturation, time step convergence information, and Newton iteration information can be transmitted between two software. Furthermore, based on the disclosure provided herein, it will be appreciated by one of ordinary skill in the art that the request and response does not need to be an one to one correspondence. It can be made such that responses can be continuously sent at one single request.

At Step 6, a request of pausing simulation was sent from the graphical visualization tool to the reservoir simulator. Based on the disclosure provided herein, it will be appreciated by one of ordinary skill in the art that other types of requests of change of simulation state can be transmitted from the graphical visualization tool to the simulator.

At Step 7, a request of changing simulation input data was sent from the graphical visualization tool to the reservoir simulator. Based on the disclosure provided herein, it will be appreciated by one of ordinary skill in the art that changing simulation input can be coupled with changing simulation state such as pause, continue, or restart simulation.

In an exemplary embodiment, the present invention is implemented in the form of control logic and/or programming instructions using computer software. The control logic and/or programming instructions can be organized in an integrated or modular manner. Based on the disclosure provided herein, a person of ordinary skill in the art will be able to implement the present invention using computer software. Alternatively, the present invention can also be implemented using hardware.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A method for real time graphical visualization of reservoir simulation data, comprising: graphical visualization of reservoir simulation data via a network communication layer.

2. The method of claim 1 wherein a network communication layer was added to both the reservoir simulator and the graphical visualization tool to facilitate transmission of reservoir simulation data between the two computer software.

3. The method of claim 1 wherein requests of reservoir information were made from the graphical visualization tool to the reservoir simulator via the network communication layer.

4. The method of claim 1 where in response to the request from the graphical visualization tool, the reservoir simulator sends reservoir information to the graphical visualization tool via the network communication layer.

5. The method of claim 1 wherein requests of change of simulation state were made from the graphical visualization tool to the reservoir simulator via the network communication layer.

6. The method of claim 1 wherein requests of change of simulation input data were made from the graphical visualization tool to the reservoir simulator via the network communication layer.

7. The method of claim 1 wherein the system is implemented using software.

8. The method of claim 2 wherein the network communicator layer is a TCP/IP or UDP network layer.

9. The method of claim 2 wherein the system is implemented using software.

10. The method of claim 3 wherein the reservoir information is fluid property, rock property, porosity, permeability, pore volume, transmissibility, pressure, saturation, time step convergence information, Newton iteration information.

11. The method of claim 3 wherein the system is implemented using software.

12. The method of claim 5 wherein the change of simulation state is pause, continue, or restart reservoir simulation.

13. The method of claim 5 wherein the system is implemented using software.

14. The method of claim 6 wherein the change of simulation input data is fluid property, rock property, porosity, permeability, pore volume, transmissibility, pressure, or saturation.

15. The method of claim 6 wherein the system is implemented using software.
